(19) United States
(12) Patent Application Publication
(10) Pub. No.: US 2005/0141508 A1
(43) Pub. Date: Jun. 30, 2005

(54) INFORMATION PROCESSING APPARATUS AND METHOD

(75) Inventor: TETSUO OGAWA, TOKYO (JP)

Correspondence Address: J C PATENTS, INC., 4 VENTURE, SUITE 250, IRVINE, CA, 92618, US

(73) Assignee: IP SQUARE INC., TOKYO (JP)

(21) Appl. No.: 10/906,836

(22) Filed: Mar. 8, 2005

Related U.S. Application Data
(63) Continuation of application No. PCT/JP03/11405, filed on Sep. 8, 2003.

(30) Foreign Application Priority Data
Sep. 9, 2002 (JP) 2002-263437

(51) Int. Cl. H04L 12/28

(52) U.S. Cl. 370/394

(57) ABSTRACT

An information processing apparatus for processing received information that is received from an exterior comprises: a processing information storing section for associatively storing, in advance, processing information indicative of processing of the received information in association with a key including at least a part of the received information; a processing information control section for extracting and supplying, as a key, at least a part of the received information to the processing information storing section, and for causing the processing information storing section to output the processing information associated with the received information; a sequencer for executing a sequence designated by the processing information outputted by the processing information storing section; and a received information processing section for processing the received information in accordance with the sequence executed by the sequencer.

The present application is a continuation application of PCT/JP2003/011 405 filed on Sep. 8, 2003, claiming a priority from a Japanese Patent Application No. 2002-263437 filed on Sep. 9, 2002, the contents of which are incorporated herein by reference.

### BACKGROUND OF THE INVENTION

1. Field of the Invention

The present invention relates to an information processing apparatus and an information processing method. More particularly, the present invention relates to the information processing apparatus for processing information received from an exterior.

2. Description of the Related Art

Conventionally it has been known such information processing apparatus that processes received packet in accordance with sequences executed by a sequencer. The information processing apparatus does a judgment in association with information indicated by the packet, in accordance with the sequence, so as to process the packet.

However, in such a conventional information processing apparatus, it may require a long time to do the judgment of the information indicated by the packet. Thus, it is difficult to process the packet at high speed conventionally.

### SUMMARY OF THE INVENTION

Therefore, it is an object of the present invention to provide an information processing apparatus and an information processing method, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an information processing apparatus for processing received information that is received from an exterior includes: a processing information storing section for associatively storing, in advance, processing information indicative of processing of the received information in association with a key including at least a part of the received information; a processing information control section for extracting and supplying, as a key, at least a part of the received information to the processing information storing section, and for causing the processing information storing section to output the processing information associated with the received information; a sequencer for executing a sequence designated by the processing information outputted by the processing information storing section; and a received information processing section for processing the received information in accordance with the sequence executed by the sequencer.

The processing information control section may receive a packet as the received information from a network, and the processing information storing section stores, in advance, the processing information in association with the key including at least a part of a header of the packet, and the received information processing section may process the packet in accordance with the sequence executed by the sequencer based on the processing information. The processing information storing section may store the processing information, in advance, of which the key is at least a part of a source IP address, a destination IP address, a source port number, or a destination port number. The received information processing section may discard the packet when the processing information storing section does not store the processing information associated with the packet which is received.

The information processing apparatus may further include: a session information storing section for storing session information indicative of a session established with a communication apparatus located outside the information processing apparatus, and the processing information control section may update the session information stored in the session information storing section, based on a header of the packet which is received when the packet received includes a TCP (Transport Control Protocol) packet. The session information storing section may newly store an entry including the session information indicate of a session in association with the TCP packet when a flag included in the header of the TCP packet indicates SYN.

The session information storing section may associatively store the session information in association with a key including at least a part of a source IP address, a destination IP address, a source port number, a destination port number, a flag, and a session ID for identifying the session, included in the header of the TCP packet. The session information storing section may store the session information including the flag, and the received information processing section may judge whether a transition state indicated by the flag of the TCP packet that is received is appropriate as a next state of the transition state indicated by the flag of the session information and when judged that the state is appropriate, may process the TCP packet, and when judged that the state is not appropriate, may discard the TCP packet. The received information processing section may transfer the TCP packet to communication apparatus which is located outside the information processing apparatus, when it is judged that the transition state indicated by the flag is appropriate as the next state.

The processing information storing section, the processing information control section, the sequencer, the received information processing section, and the session information storing section may be formed monolithically in a semiconductor chip as an electronic circuit. The information processing apparatus may further include: a path information storing part for storing a path information indicative of a path through which the packet is to be transferred, formed monolithically in the semiconductor chip and the received information processing section may transfer the packet to a communication apparatus located outside the information processing apparatus designated by the path information. The processing information storing section, the session information storing section, and the path information storing part may be implemented as a content-addressable memory outputting any of the processing information, the session information, and the path information according to the key which is inputted.

The information processing apparatus may further include: a code processing part for decoding the packet coded with a encryption method which is predetermined, and the processing information control section may judge whether the packet is coded with the encryption method and when the packet coded with the encryption method, then cause the code processing part to decode the packet and extract at least a part of the header of the packet which is decoded, and supply that to the processing information storing section as at least a part of the key, and the processing information part may output the processing information associated with the key.

According to the second aspect of the present invention, an information processing method for processing a received information that is received from an exterior, including the steps of: extracting at least a part of the received information; supplying at least a part of the received information extracted as at least a part of a key to a processing information storing section for associatively storing, in advance, processing information indicative of processing received information in association with a key including at least a part of the received information and causing the processing information storing section to output the processing information associated with the received information; executing sequence designated by the processing information outputted from the processing information storing section, and; processing the received information in accordance with the sequence.

The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary structure of a home gateway 100 concerning one embodiment of the present invention.

FIG. 2 is a block diagram showing a structure of the information processing unit 102.

FIG. 3 shows an example of the structure of the processing information control section 202.

FIG. 4 shows an example of the information for identifying the flow of the processing to the packet, which is predetermined by the user.

FIG. 5 shows an example of a key corresponded to the processing information by CAM 204.

FIG. 6 shows an example of a key corresponded to the session information by CAM 204.

FIG. 7 is an example of the flow chart of information processing unit 102.

FIG. 8 is an example of the flow chart of the packet relaying section 212, at the step of S122.

FIG. 9 is an example of the flow chart of the transfer processing section 21 4, at the step of S124.

FIG. 10 shows another example of a key corresponded to the processing information by CAM 204.

FIG. 11 shows another example of a key corresponded to the session information by CAM 204.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

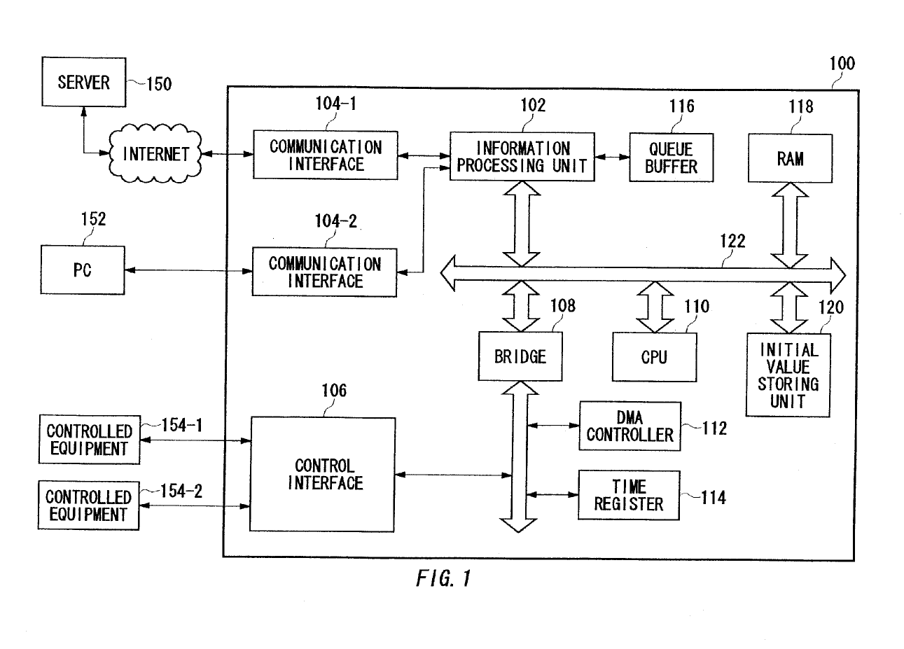

FIG. 1 shows an exemplary structure of a home gateway 100 concerning one embodiment of the present invention. In this embodiment, the home gateway 100 processes a packet received from an external communication equipment at high-speed, and transfers the packet to other external communication equipment. The home gateway 100 may include a facility of a router.

The home gateway 100 includes a plurality of communication interfaces 104-1 and 104-2, a control interface 106, an information processing unit 102, a queue buffer 116, a CPU 110, a RAM 118, an initial value storing unit 120, a DMA controller 112, a time register 114, a bridge 108 and a bus 122.

Each of the communication interfaces 104-1 and 104-2 is connected to the sever 150 and a personal computer 152 so as to communicate with each other, thereby transmitting and receiving the packets. Each of the communication interfaces 104-1 and 104-2 may be Ethernet or a serial interface, for example. In addition, in this embodiment, the communication interface 104-1 is connected to the sever 150 via Internet.

The control interface 106 is connected to a plurality of the controlled equipments 154-1 and 154-2 so as to communicate with each other, thereby controlling them. The control interface 106 may be an interface based on such standard interfaces, for example 802.11b, USB, Bluetooth or IEEE1394 and the control interface 106 transmits and receives the packet over the plurality of the controlled equipments 154-1 and 154-2, in order to control them.

In addition, each of the server 150, the personal computer 152 and the controlled equipments 154-1 and 154-2 is an example of the communication equipment located outside the home gateway 100. These communication equipments may be connected to the communication interface 104-1 and 104-2 or the control interface 106 via a network such as a LAN (Local Area Network). In addition, each of the controlled equipments 154-1 and 154-2 may be an information appliance such as a digital set-top box, a digital television receiver, a home-use game machine, PDA or a portable telephone. Each of the controlled equipments 154-1 and 154-2 may be digital equipment such as a digital camera, a HDD recorder, or a DVD player. The controlled equipments 154-1 and 154-2 may be a home electric appliance such as an air-conditioner or a refrigerator. The controlled equipments 154-1 and 154-2 may be various sensors such as a thermometer or a pressure sensor.

The information processing unit 102 is an example of an information processing apparatus concerning the present invention, and the information processing unit 102 processes information received from the outside of the home gateway 100. In this embodiment, the information processing unit 102 receives a packet based on the IP (Internet Protocol), as an example of the received information, from the server 150, the personal computer 152 or the controlled equipments 154-1 or 154-2 and then processes the packet.

The information processing unit 102 is connected to the sever 150 and the personal computer 152 via the plurality of the communication interfaces 104-1 and 104-2 and is also connected to the plurality of the controlled equipments 154-1 and 154-2 via the control interface 106, bridge 108, and bus 122. The information processing unit 102 receives packets from one of the server 150, personal computer 152, controlled equipment 154-1 or 154-2, and then, transfers the received packet to other communication equipments.

The queue buffer 116 is such a memory like DRAM and storages temporarily the packet transferred from the information processing unit 102, as a queue. In addition, The CPU 110 controls semantics of the home gateway 100. The RAM 118 is a memory referred to by CPU 110. The initial value storing unit 120 may be such a nonvolatile memory like a flash memory, and stores the information that is to be set to the information processing unit 102 during the start-up process of the home gateway 100.

DMA controller 112 controls the transferring of data between the control interface 106 and the RAM 118. The time register 114 controls synchronism of the semantics of the home gateway 100. For example, the time register 114 may include a facility of watch dock time register. According to this embodiment, received packets can be processed adequately and transferred.

Here, the home gateway 100 may communicate with the sever 150, for example, based on SNMP (Simple Network Management Protocol) or other protocols, so as to control the controlled equipments 154-1 and 154-2. The home gateway 100 may send information for transmission based on the information received from the controlled equipment 154-1 and 154-2, to the server 150 or others.

For example, when a camera, which is an example of the controlled equipment 154, detects some troubles around the camera, based on the image monitored by the camera, the home gateway 100 may transmit information for transmission indicative of the troubles, for example using the SNMP. In addition, the home gateway 100 may detect whether the state of the door or gate is opening or closing, based on outputs of magnetic sensors attached to the door or the gate and then send the result of the detection to the server 150. In these cases, it is possible to monitor the states of the house including the home gateway 100 properly from the outside of the house. Accordingly, a disaster prevention system for controlling and monitoring the states of the house or other systems can be provided properly.

In addition, for example, the home gateway 100 may read use of the quantity such as water service, gas service or electricity service and send the result of the inspection of such meters to the server 150. In this case, it is possible to monitor the lifeline of the house or other buildings including the home gateway 100 properly.

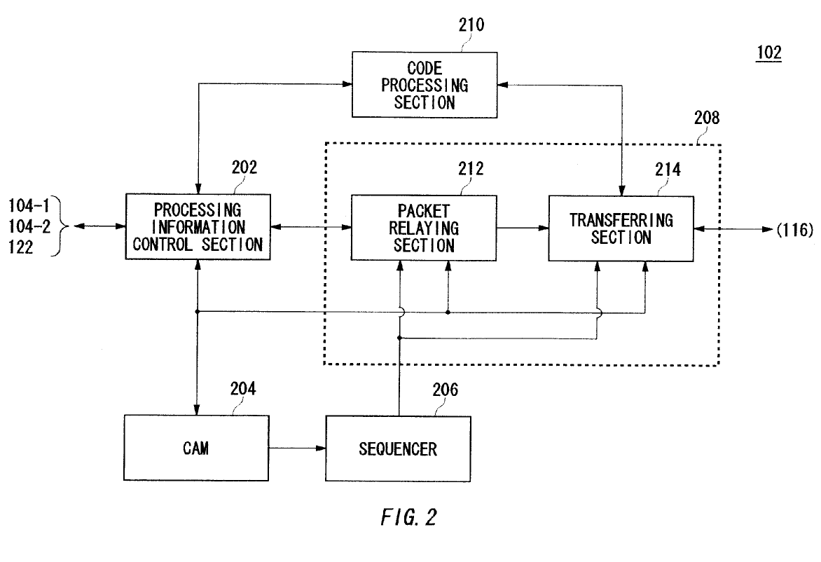

FIG. 2 shows a detailed structure of the information processing unit 102. Information processing unit 102 includes CAM 204, processing information control section 202, sequencer 206, packet processing part 208 and code processing section 210.

The CAM 204 is an example of the content-addressable memory and associatively stores, in advance, processing information indicative of processing of received packets in association with a key including at least a part of a header of the packet that is to be received. Thus, the CAM 204 includes a facility of the processing information storing section. The CAM 204 outputs the processing information in association with an entry (a row) of which keys accord with the key received from the outside. In this embodiment, the CAM 204 receives the processing information from the initial value storing unit 120 (see FIG. 1) and then stores them during the start-up process of the home gateway 100 (see FIG. 1).

In addition, CAM 204 further includes a facility of session information storing section for storing the session information indicative of a session established with the communication equipments located outside the home gateway 100. In this embodiment, the CAM 204 further includes a facility of the path information storing part for storing path information indicative of a path through which the packet is to be transferred. In other words, in this embodiment, the processing information storing section, the session information storing section, and the path information storing part are implemented to the CAM 204, and output any of the processing information, the session information, and the path information according to the keys inputted.

The processing information control section 202 extracts at least a part of the hearer of the packet received by the home gateway 100 and supplies the part of the header as a key to the CAM 204, so as to cause the CAM 204 to output the processing information associated with the packet. When the received packet includes TCP (Transport Control Protocol) packet, the processing information control section 202 updates the session information stored in the CAM 204 based on the header of the TCP packet.

The sequencer 206 selects a sequence designated by the processing information outputted by the CAM 204 and executes the sequence. Accordingly, the sequencer 206 rapidly determines the sequence which is to be executed when processing the packet, based on the processing information stored in the CAM 204, and executes the sequence in accordance with the packet immediately. Thus, according to this embodiment, the received packet can be processed at high speed.

In addition, the packet processing part 208 processes the packet in accordance with the sequence executed by the sequencer 206. Thus, according to this embodiment, the packet can be processed since the circuit is designed to be versatile. Accordingly, it is possible to provide the home gateway 100 at low cost. Therefore, according to this embodiment, the information processing apparatus for processing the packet at high speed can be provided at low cost. Here, the packet processing part 208 is an example of the received information processing section.

In this embodiment, the packet processing part 208 has a packet relaying section 212 and a transferring section 214. The packet relaying section 212 judges whether relaying the packet to the transferring section 214, based on the header of the packet, in accordance with the sequence executed by the sequencer 206. When not transferring the packet to the transferring section 214, the packet relaying section 212 discards the packet.

For example, when the CAM 204 does not store the processing information in association with the received packet, the packet relaying section 212 discards the packet. In addition, the packet relaying section 212 compares the header of the received packet with the session information stored in the processing information control section 202 so as to judge whether the received TCP packet is appropriate, and discards an inappropriate TCP packet when the packet is not appropriate. In this case, the packet relaying section 212 may do the judgment based on the information stored in CAM 204 as a key associated with the session information. Thus, home gateway 100 can transfer the packet safely.

The transferring section 214 transfers the packets to the communication equipments designated by the path information stored in the CAM 204. In this embodiment, the transferring section 214 stores the packets which is to be transferred into the queue buffer 116 temporarily, and then executes the step of transferring in accordance with the sequence executed by the sequencer 206. In this case, the transferring section 214 may judge a priority for transferring the packets, based on the processing information, and then, transfer the packet according to this priority. The transferring section 214 may judge whether the step of transferring the packet is executed or not, based on the processing information.

The code processing section 210 decodes the packets coded with a predetermined encryption method such as DES (Data Encryption Standard), triple DES and so on. For example, when home gateway 100 receives the packet that is coded, the code processing section 210 encodes the packets according to the processing information control section 202. In this case, the processing information control section 202 may judge whether the step of decoding is executed or not, based on the header of the packets and the processing information in association with the packets, according to the indication, and when it is required the decoding step, the processing information control section 202 may select a encryption method corresponding to the packets from a plurality of predetermined encryption methods and decode this packet.

Further, the code processing section 210 may code the packets which are transferred to the outside of the home gateway 100, in accordance with the indication of the transferring section 214. The processing information control section 202 may execute the steps of coding and decoding with respect to the ESP (Encapsulating Security Payload) of IPsec and the step of generating the common key (Diffie-Hellman).

In this embodiment, the CAM 204, the processing information control section 202, the sequencer 206, the packet processing part 208 and the code processing section 210 are formed monolithically in a semiconductor chip as a electronic circuit. Thus, according to this embodiment, it is possible to provide the home gateway 100 at a lower cost.

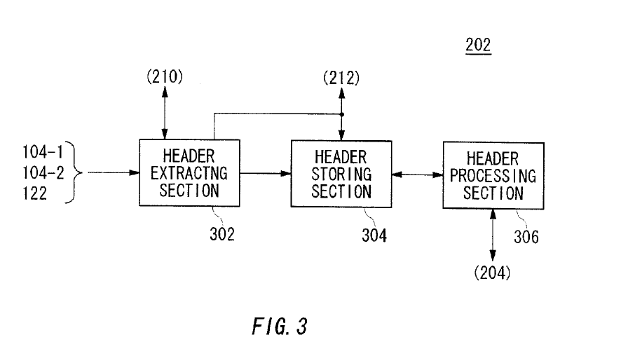

FIG. 3 shows an example of the structure of the processing information control section 202. The processing information control section 202 has a header extracting section 302, a header storing section 304 and a header processing section 306. In this embodiment, the CAM 204 stores class ID in advance, which is an example of the processing information. The class ID is such information that indicates the flow of the processing of the packet, and for example predetermined by user.

The header extracting section 302 extracts the header from the received frame of the packet received by the home gateway 100 and causes the header storing section 304 to capture the header that is extracted. Further, the header extracting section 302 recognizes the protocol of the packet and the application corresponding, in accordance with the header that is extracted. It is preferable that the header extracting section 302 verifies the validity of the header by means of the checksum of the header or the version information indicated by the header.

When coded packet is received, the header extracting section 302 causes the code processing section 210 to decode this packet. The header extracting section 302 provides the received packet to the packet relaying section 212.

The header storing section 304 is a resister that temporarily stores the header information indicative of the description of the header that is extracted by the header extracting section 302. The header storing section 304 outputs the header information to the packet relaying section 212 and the header procession section 306, according to each of their requests.

The header procession section 306 acquires the class ID from CAM 204, based on the header information stored in the header storing section 304. Thus, the header processing section 306 classifies the packet into the classes that is predetermined by the user. And the sequencer 206 (see FIG. 2) executes the sequence associated with the class ID of the packet. Therefore, according to this embodiment, the sequencer 206 can execute the sequence corresponding to the received packet immediately.

In addition, the header procession section 306 updates the session information stored in the CAM 204 based on the header of the packet. Thus, it is possible to manage the session properly.

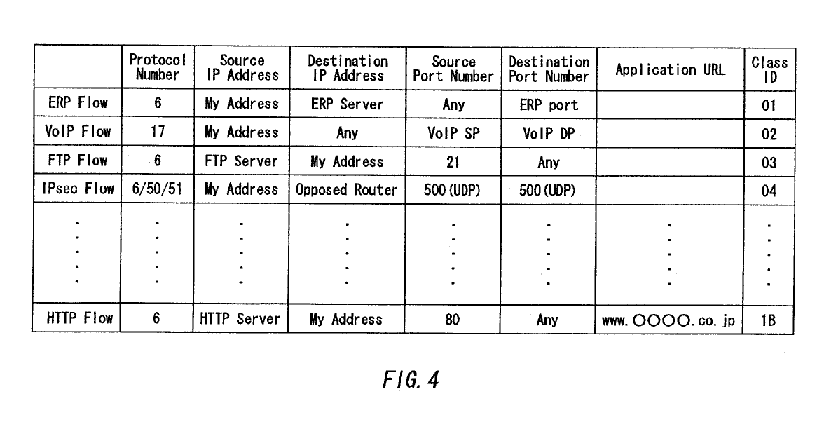

FIG. 4 shows an example of the information for identifying the flow of the processing to the packet, which is predetermined by the user. The CAM 204 may store the processing information in association with a key including at least a part of the information indicated in FIG. 4. In this embodiment, the header processing section 306 inputs a key including at least one part of a protocol number, a source IP address, a destination IP address, a source port number, a destination port number and an URL referred to by application, to the CAM 204 and acquires class ID corresponding to an entry according with the key from CAM 204. Thus, the header processing section 306 classifies the packet into the classes.

For example, when the protocol number of the headed of the received packet is 6, and the source IP address is an address of self-address (the address of home gateway 100), and the destination IP address is an address of ERP (Enterprise Resource Planning) server, and the source port number is discretionary, that is, any source port number is applicable, and the destination port number indicates the port number of the ERP, then the CAM 204 outputs the value 01 which indicates the class ID for processing the flow of the packet based on the ERP, according to the key from the header processing section 306.

In addition, when the protocol number is 17, and the source IP address is the self-address, and the destination IP address is discretionary, that is, any destination IP address is applicable, and the source port number indicates the source port number of VoIP (Voice over IP) and the destination port number indicates the destination port number of VoIP, then the CAM 204 outputs the value 02 which indicates the class ID corresponding to the packet based on VoIP.

When the protocol number is 6, and the source IP address is FTP (File Transfer Protocol) server, and the destination IP address is self-address, and the source port number is 21, and the destination port number is discretionary, that is, any destination port number is applicable, then the CAM 204 outputs the value 03 which indicates the class ID corresponding to the packet based on FTP.

When the protocol number is 6, 50 or 51 and the source IP address is self-address, and the destination IP address is an address of the opposed router, and the source port number is 500 of UDP (User Datagram Protocol), and the destination port number is 500 of UDP, then the CAM 204 outputs the value 04 which indicates the class ID corresponding to the packet based on IPsec (IP Security).

When the protocol number is 6, and the source IP address is an address of the HTTP (Hyper Text Transfer Protocol) server, and the destination IP address is self-address, and the source port number is 80th, and the destination port number is discretionary, and the URL referred by application is predetermined URL, then the CAM 204 outputs the value 1B which indicates the class ID corresponding to the packet based on HTTP.

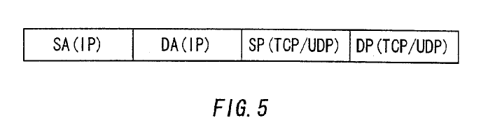

FIG. 5 shows an example of a key associated with the processing information by the CAM 204. In this embodiment, the CAM 204 previously stores the processing information including the source IP address (SA), the destination IP address (DA), the source port number (SP), and the destination port number (DP) as a key, which are to be included in the packet. In another example, CAM 204 may store the processing information in association with keys including at least a part of them.

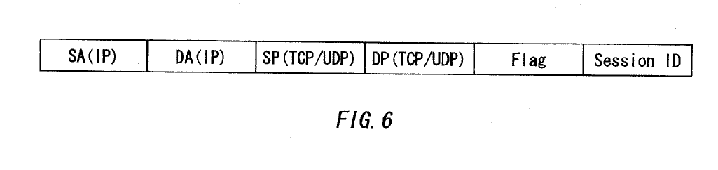

FIG. 6 shows an example of a key associated with the session information by the CAM 204. The CAM 204 stores session information associated with keys which are predetermined with respect to each session, as the entries indicating the sessions. In this embodiment, the CAM 204 associatively stores session information in association with the keys including the source IP address, the destination IP address, the source port number, the destination port number, the flag for indicating the state of the transition of the TCP, and the session ID for identifying the session, which are included in the header of the TCP packet based on the TCP (Transport Control Protocol). In another example, the CAM 204 may store the session information in association with keys including at least a part of them.

The CAM 204 may store the class ID corresponding to the session, in association with the keys, as the session information. Thus, the home gateway 100 can execute the session processing of the packet according to the class of the packet properly.

In addition, the CAM 204 identifies a plurality of the sessions recorded in the CAM 204 in accordance with the session ID. In this embodiment, the CAM 204 receives the session ID from the processing information control section 202 (see FIG. 2). When the home gateway 100 establishes a new session with the external communication equipment, the processing information control section 202 generates session ID in association with this session, and stores the entry in association with new session information in the CAM 204. According to this embodiment, it is possible to manage the session properly.

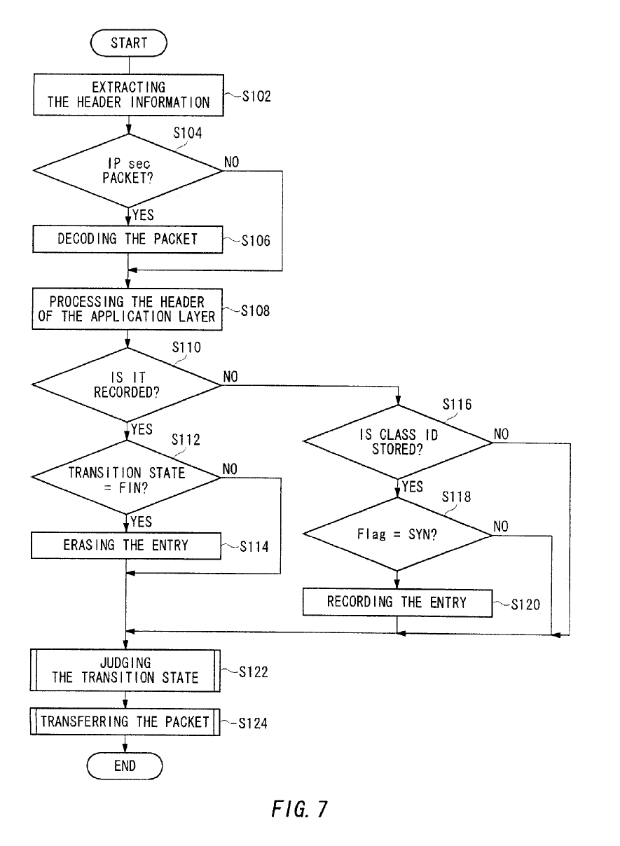

FIG. 7 is an example of the flow chart of information processing unit 102. At first the processing information control section 202 extracts a header of the packet received by the home gateway 100 (S102) and judges whether the packet is based on IPsec or not. (S104). Thus, the processing information control section 202 judges whether a packet is coded with a predetermined encryption method or not. The information processing unit 102 may acquire the class ID from the CAM 204 based on the header extracted at the step of S102, so as to do the judgment in accordance with the class ID that is acquired.

Next, if the received packet is based on IPsec, the processing information control section 202 causes the code processing section 210 to decode this packet (S106) and extracts a header of application layer in order to process this header extracted if it is required. (S108). While, when the received packet is not based on the IPsec at the step of S104, then this process goes on to the step S108.

In addition, at the step S106, the processing information control section 202 may extract at least a part of the header of the packet that is decoded and supply this to the CAM 204 as a key corresponding to the processing information. In this case, the processing information control section 202 acquires anew the class ID associated with the packet that is decoded.

Next to the step S108, the processing information control section 202 judges whether a received packet is recorded in the CAM 204 (S110). When an entry associated with this session is stored in CAM 204, the processing information control section 202 judges that the session has already been recorded. And when a session is recorded, and a flag of an entry corresponding shows the transition state FIN of TCP (S112), the processing information control section 202 erases the entry corresponding to the session in the CAM 204 (S114) and then this process proceeds to the step S122.

While, when a received packet is not recorded in CAM 204 at the step S110, and when the CAM 204 stores class ID associated with this packet (S116) and the flag of this packet shows the transition state SYN (S118), then the processing information control section 202 causes the CAM 204 to store an entry corresponding to this session anew, so as to record the session (S120) and then this process proceeds to the step S122.

When the flag does not show the transition state FIN at the step S112, or when the CAM 204 does not store class ID associated with the packet at the step S116, or when the flag does not show the transition state SYN at the step S118, then the process goes on to the step S122.

Next, the packet relaying section 212 judges whether the transition state indicated by the flag of the packet is appropriate or not (S122), and the transfer processing section 214 transfers the packet of which transition states is judged to be appropriate (S124). According to this embodiment, it is possible to manage the session associated with the packet and transfer the packet properly.

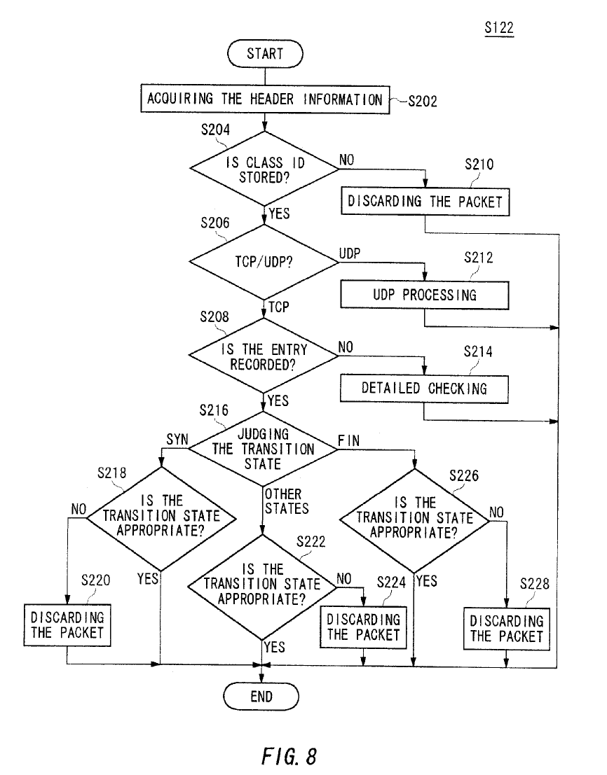

FIG. 8 is an example of the flow chart of the packet relaying section 212, at the step S122 (see FIG. 7). At first, the packet relaying section 212 acquires the header information of the packet from the header storing section 304 (S202) and judges whether the CAM 204 stores the class ID in association with this packet, based on the header information (S204).

When the class ID is stored, and when the packet includes TCP packet (S206) and when the entry associated with the session of this TCP packet is recorded in CAM 204 (S208), then the packet relaying section 212 identifies the transition state indicated by the flag included in the keys (see FIG. 6) associated with this entry (S216). In this case, the packet relaying section 212 may mask some of the keys, and supply other keys which are not masked. For example the packet relaying section 212 may mask the flag and the session ID, and supply the source IP address, the destination IP address, the source port number and the destination port number as the keys. Thus, the packet relaying section 212 acquires the flag included in the entry.

Next, the packet relaying section 212 judges whether the transition states indicated by the flag of the TCP packet is appropriate or not (S218, S222, S226). When the judgment is appropriate, the packet relaying section 212 finishes processing and the step executed by the information processing unit 102 goes to the step S124 (see FIG. 7). While, when the judgment is not appropriate, the packet relaying section 212 discards this TCP packet (S220, S224, S228) and finishes processing.

In this embodiment, at the step S216, the packet relaying section 212 identifies whether the state of the flag included in the key is SYN, FIN or other states. And when identified to be SYN, the packet relaying section 212 does the judgment of the establishment of the session at the step S218, so as to judge whether the transition states indicated by the flag of TCP packet is appropriate.

When identified to be FIN, the packet relaying section 212 does the judgment of the closing of the session at the step S226, so as to judge whether the transition states indicated by the flag of TCP packet is appropriate. When identified to be other states, the packet relaying section 212 does the judgment of transferring the packet, base on the packet that is received or transmitted at the step S222, so as to judge whether the transition states indicated by the flag of TCP packet is appropriate. According to this embodiment, it is possible to judge whether the transition states of the packet is appropriate at high speed, base on the session information stored in the CAM 204. Thus, the received packet can be processed at high speed.

Here, at the step S204, when it is judged that the class ID in association with the packet is not stored, the packet relaying section 212 discards the packet (S210) and next finishes processing. In addition, at the step S206, when the packet is judged to be a packet based on UDP, the packet relaying section 212 executes the UDP processing that is predetermined (S212) and next, finishes processing. At the step S208, when the session in association with the TCP packet is not recorded in CAM 204, the packet relaying section 212 executes such detailed checking processes like a checking of the option field in the IP header or a checking of the application layer (S214) and next, finishes processing.

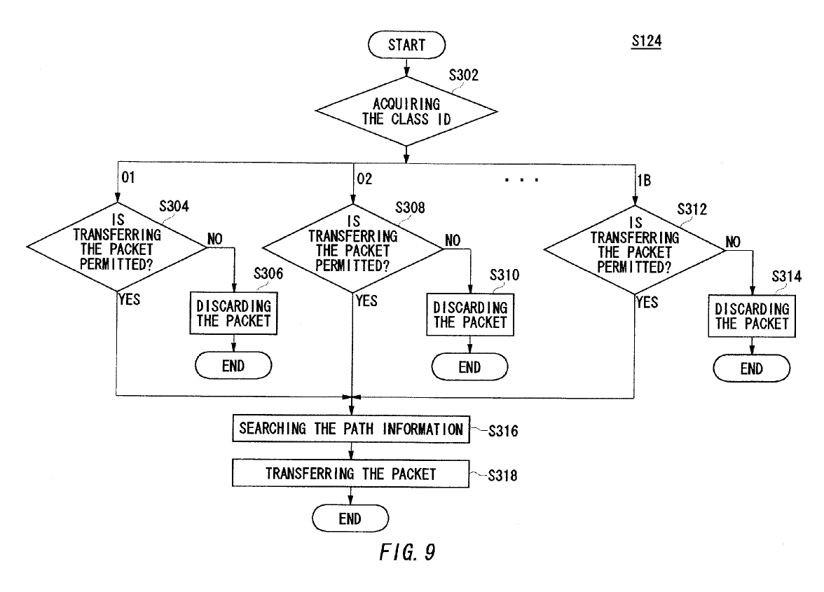

FIG. 9 is an example of the flow chart of the transfer processing section 214, at the step of S124 (see FIG. 7). At first, the transferring section 214 inputs key based on the header information of the packet into the CAM 204 and acquires the class ID associated with the packet (S302).

Next, the transfer processing section 214 judges whether transferring this packet is permitted on the basis of the class ID (S304, S308, S312). In this case, the sequencer 206 executes the sequence designated by the class ID and the transfer processing section 214 executes any step of S304, S308 or S312, in accordance with this sequence.

In this embodiment, the transfer processing section 214 classifies the packet into the classes at high speed, based on both the header of the packet and the class ID stored in the CAM 204. In addition, the transferring section 214 judges properly whether the step of transferring is to be executed, based on the flow of the steps designated by the class ID. Thus, according to this embodiment, the process of packet can be executed rapidly and properly.

And when the step of transferring is permitted, the transferring section 214 searches path information stored in the CAM 204 (S316), and transfers the packet in accordance with this path information (S318). While, when the step of transferring is not permitted at the steps S304, S308, or S312, the transferring section 214 discards the packet (S306, S310, and S314). According to this embodiment, it is possible to judge whether the step of transferring is to be executed rapidly and properly and transfer the packet.

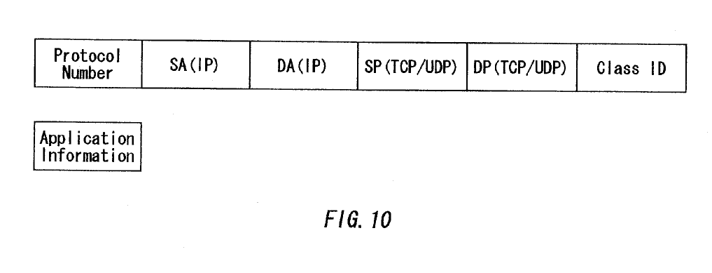

FIG. 10 shows another example of a key corresponded to the processing information by the CAM 204. In this example, the CAM 204 further stores the protocol number, the application information, and the class ID as keys, which are to be included in the header of the packet. In this case, it is possible to classify the packets into more detailed classes, so as to execute the processes corresponding to these classes. Thus, it is possible to process the packet properly.

In addition, the processing information control section 202 may mask any of the protocol number, the source IP address, the destination IP address, the source port number, the destination port number, the class ID, and the application information and transfer the source IP address and the destination IP address to the CAM 204 as the key, for example, so as to acquire the class ID. In addition, the CAM 204 may use the URL used by HTTP application, as the application information included in the key, an example of the information included in the header of the application layer.

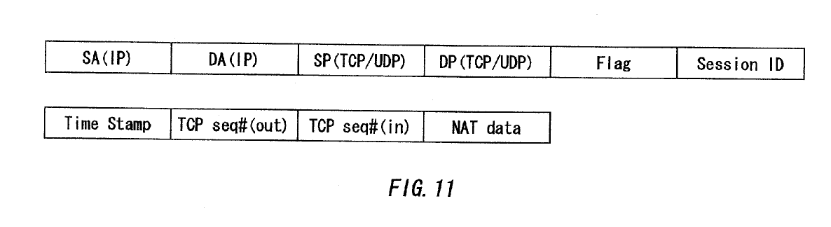

FIG. 11 shows another example of a key corresponded to the session information by CAM 204. In this example, CAM 204 further stores the session information of which keys are the time stamp, the sequence number of the transmitted packet (TCP seq # in)), and destination information (NAT data), which are included in the header of the TCP packet. According to this example, a session can be managed more in detail.

The CAM 204 may record the receiving time of the SYN packet with which the session is established, as the time stamp. Thus, for example, even if a plurality of packet corresponding to the same session ID are received, it is possible to judge the consistency of these packets based on the time difference between the receiving time and the time stamp.

The packet relaying section 212 may judge whether the received packet is appropriate, based on the sequence number of the transmitted packet and/or the received packet and the ACK number of the transmitted packet and/or the received packet, and judge whether the step of transferring is to be executed, based on the destination information. The transferring section 214 may transfer the packet to the communication equipment designated by the destination information. In this example, it is possible to manage the session more properly and process the packet. As is apparent from the description, according to the present invention, the information processing apparatus which process a packet at high speed can be provided in low cost.

Although the present invention has been described by way of exemplary embodiments, it should be understood that those skilled in the art might make many changes and substitutions without departing from the spirit and the scope of the present invention which is defined only by the appended claims.

1. An information processing apparatus for processing received information that is received from an exterior comprising:
a processing information storing section for associatively storing, in advance, processing information indicative of processing of the received information in association with a key including at least a part of the received information;
a processing information control section for extracting and supplying, as a key, at least a part of the received information to said processing information storing section, and for causing said processing information storing section to output the processing information associated with the received information;
a sequencer for executing a sequence designated by the processing information outputted by said processing information storing section; and
a received information processing section for processing the received information in accordance with the sequence executed by said sequencer.

2. An information processing apparatus as claimed in claim 1, wherein
said processing information control section receives a packet as the received information from a network,
said processing information storing section stores, in advance, the processing information in association with the key including at least a part of a header of the packet, and
said received information processing section processes the packet in accordance with the sequence executed by said sequencer based on the processing information.

3. An information processing apparatus as claimed in claim 2, wherein said processing information storing section stores the processing information, in advance, of which the key is at least a part of a source IP address, a destination IP address, a source port number, or a destination port number.

4. An information processing apparatus as claimed in claim 2, wherein said received information processing section discards the packet when said processing information storing section does not store the processing information associated with the packet which is received.

5. An information processing apparatus as claimed in claim 1, further comprising:
a session information storing section for storing session information indicative of a session established with a communication equipment located outside said information processing apparatus, and
wherein said processing information control section updates the session information stored in said session information storing section, based on a header of the packet which is received when the packet received includes a TCP (Transport Control Protocol) packet.

6. An information processing apparatus as claimed in claim 5, wherein said session information storing section newly stores an entry including the session information indicate of a session in association with the TCP packet when a flag included in the header of the TCP packet indicates SYN.

7. An information processing apparatus as claimed in claim 5, wherein said session information storing section associatively stores the session information in association with a key including at least a part of a source IP address, a destination IP address, a source port number, a destination port number, a flag, and a session ID for identifying the session, included in the header of the TCP packet.

8. An information processing apparatus as claimed in claim 7, wherein said session information storing section stores the session information including the flag, and said received information processing section judges whether a transition state indicated by the flag of the TCP packet that is received is appropriate as a next state of the transition state indicated by the flag of the session information and when judged that the state is appropriate, processes the TCP packet, and when judged that the state is not appropriate, discards the TCP packet.

9. An information processing apparatus as claimed in claim 8, wherein said received information processing section transfers the TCP packet to communication equipment which is located outside said information processing apparatus, when it is judged that the transition state indicated by the flag is appropriate as the next state.

10. An information processing apparatus as claimed in claim 5, wherein said processing information storing section, said processing information control section, said sequencer, said received information processing section, and said session information storing section are formed monolithically in a semiconductor chip as an electronic circuit.

11. An information processing apparatus as claimed in claim 10, further comprising:
a path information storing part for storing a path information indicative of a path through which the packet is to be transferred, formed monolithically in said semiconductor chip, and wherein
said received information processing section transfers the packet to a communication equipment located outside said information processing apparatus designated by the path information.

12. An information processing apparatus as claimed in claim 11, wherein said processing information storing section, said session information storing section, and said path information storing part are implemented as a content-addressable memory outputting any of the processing information, the session information, and the path information according to the key which is inputted.

13. An information processing apparatus as claimed in claim 2, further comprising:
a code processing part for decoding the packet coded with a encryption method which is predetermined, and wherein
said processing information control section judges whether the packet is coded with the encryption method and when the packet coded with the encryption method, then causes said code processing part to decode the packet and extracts at least a part of the header of the packet which is decoded, and supplies the same to said processing information storing section as at least a part of the key, and
said processing information part outputs the processing information associated with the key.

14. An information processing method for processing received information that is received from an exterior, comprising the steps of:
extracting at least a part of the received information;
supplying at least a part of the received information extracted as at least a part of a key to a processing information storing section for associatively storing, in advance, processing information indicative of processing received information in associate with a key including at least a part of the received information and causing said processing information storing section to output the processing information associated with the received information;
executing sequence designated by the processing information outputted from said processing information storing section, and;
processing the received information in accordance with the sequence.
